(19) United States
(12) Patent Application Publication
(10) Pub. No.: US 2010/0157452 A1
(43) Pub. Date: Jun. 24, 2010

(54) Solid Surface that Changes Colors on Command

(76) Inventor: Rachid Belharti, Khemisset (MA)

Correspondence Address: Rachid Belharti, c/o Mary Blakney, 30 Sugar House Rd, Washington, NH, 03280, US

(21) Appl. No.: 12/339,530

(22) Filed: Dec. 19, 2008

(51) Int. Cl. G02B 5/24; G02B 1/06

(52) U.S. Cl. 359/886

(57) ABSTRACT

The surface of the color-changing object is composed of one or more display reservoirs capable of containing a fluid or granular solid. At least a portion of each reservoir is transparent or translucent. Each reservoir is connected to one or more color-storage capsules containing fluid or granular solid. To change the color of the object, a fluid or granular solid is caused to flow from a capsule(s) into a reservoir(s). The fluid or granular solid will then be visible through the transparent or translucent portion(s) of the reservoir(s), thereby changing the color of the obiect.

NOTE: It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of part within the principles of the invention to the full extent indicated by the broad general meaning of the terms in which the appended claims are expressed.

### (2) REFERENCES CITED

U.S. Pat. No. 4,384,419 Parr

### (6) BACKGROUND OF THE INVENTION

I. Field of the Invention

The present invention is related to the surfaces of constructed and/or manufactured items, including but not limited to buildings, automobiles, walls (interior and exterior), windows, and personal accessories.

II. Description of Related Art

Conventional Surfaces

Most conventional surfaces cannot change colors. Those that can, require an environmental stimulus, such as a temperature change, to effect the color change, and can offer only a very limited selection of colors. The invention allows a surface to change based solely on the choice of the user, and the number of colors from which the user may choose has no specified limit.

Paramagnetic Polymer Technology

It is rumored that a technology currently in development would cause the exterior surface of an automobile to change colors according to the choice of the user. An electric current is sent through paramagnetic polymer paint, changing the way the paint reflects light, thus changing its color. When the electric current is interrupted, the surfaces color reverts to white.

The invention does not require paramagnetic materials, but is compatible with readily available low-cost materials such as glass, fiberglass and various plastics.

The invention can be activated either electrically or mechanically, therefore does not necessarily require the consumption of energy (except, of course, for the energy consumed by the user in the act of pushing a button).

The invention does not require energy to maintain a given color, so an automobile, for example, embodying the invention, would remain in the users desired color(s) and pattern, even when switched off.

Color Changing Display

U.S. Pat. No. 4,384,419 is for a Color Changing Display which requires moveable mechanical arms powered by a motor, and must be placed vertically or near vertically. Any given location on said Display can offer a maximum of two color choices.

The invention requires neither moveable arms nor motors. Therefore it produces less noise and requires less maintenance for the benefit provided.

The number of color choices provided by the invention has no maximum, except as imposed by practicality. Even in its simplest embodiments, the number of colors offered per location would never need to be as low as two.

The invention can be embodied in surfaces which occupy any position, or which change position, or which are intended for a weightless environment.

### (7) BRIEF DESCRIPTION OF THE INVENTION

The main objective of the invention is to provide solid surfaces which change colors on command.

Other objectives, advantages and novel features of the invention will become more apparent from the following detailed description when taken in conjunction with the following drawings.

### (8) BRIEF DESCRIPTION OF THE SEVERAL VIEWS OF THE DRAWING

FIG. 1 Diagram of the invention.

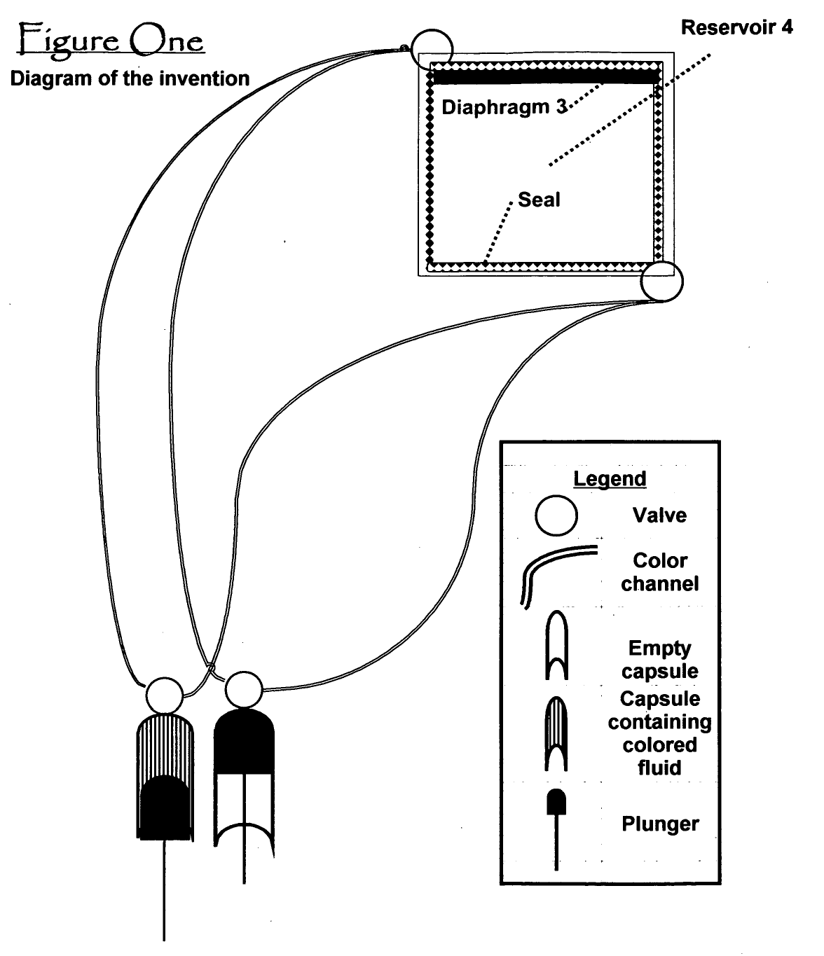

FIG. 2 Reservoir, end view

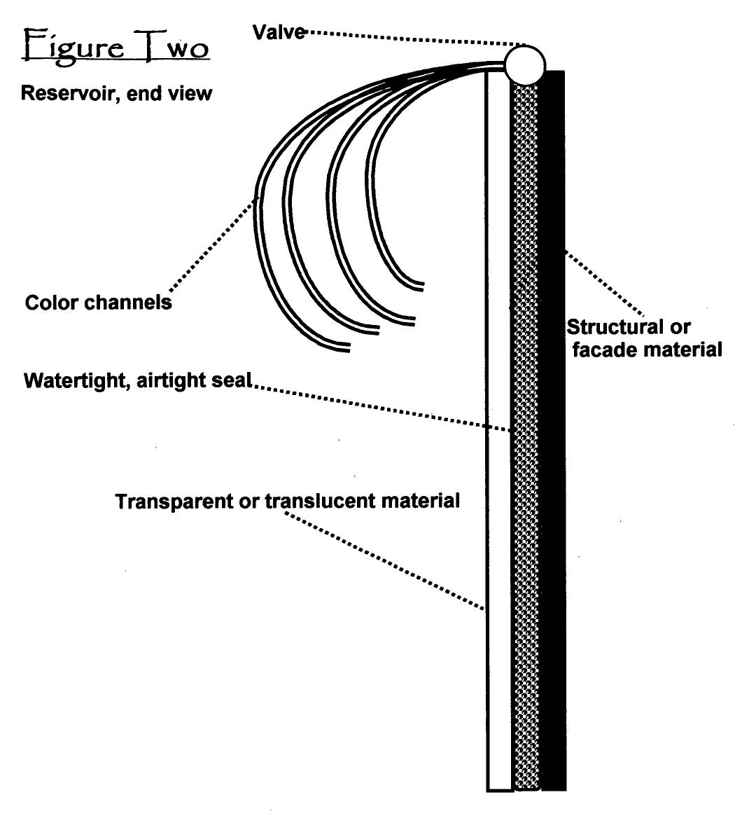

FIG. 3 Reservoir, cross-section view

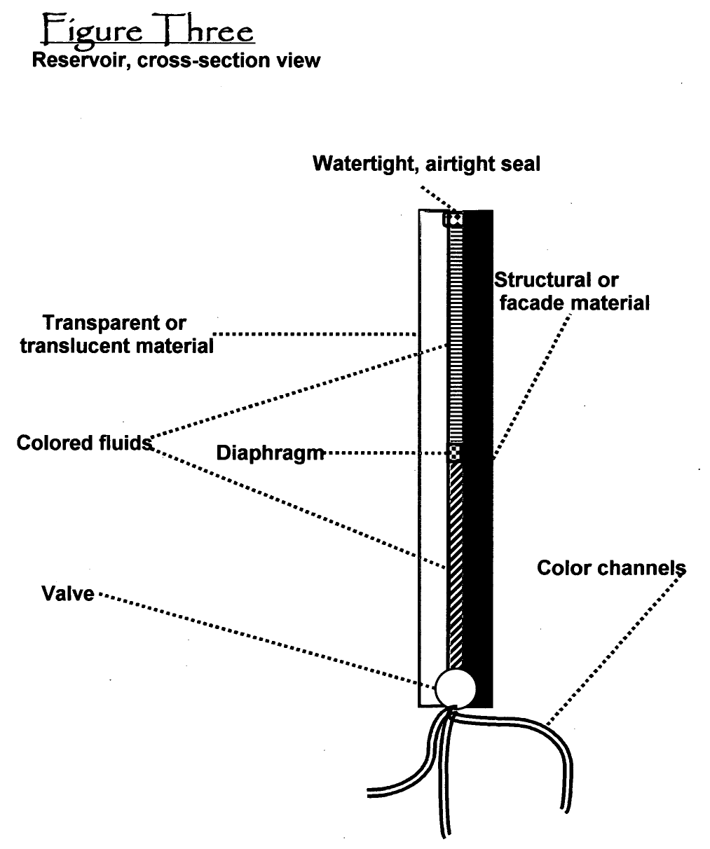

FIG. 4 Diagram of Embodiment One

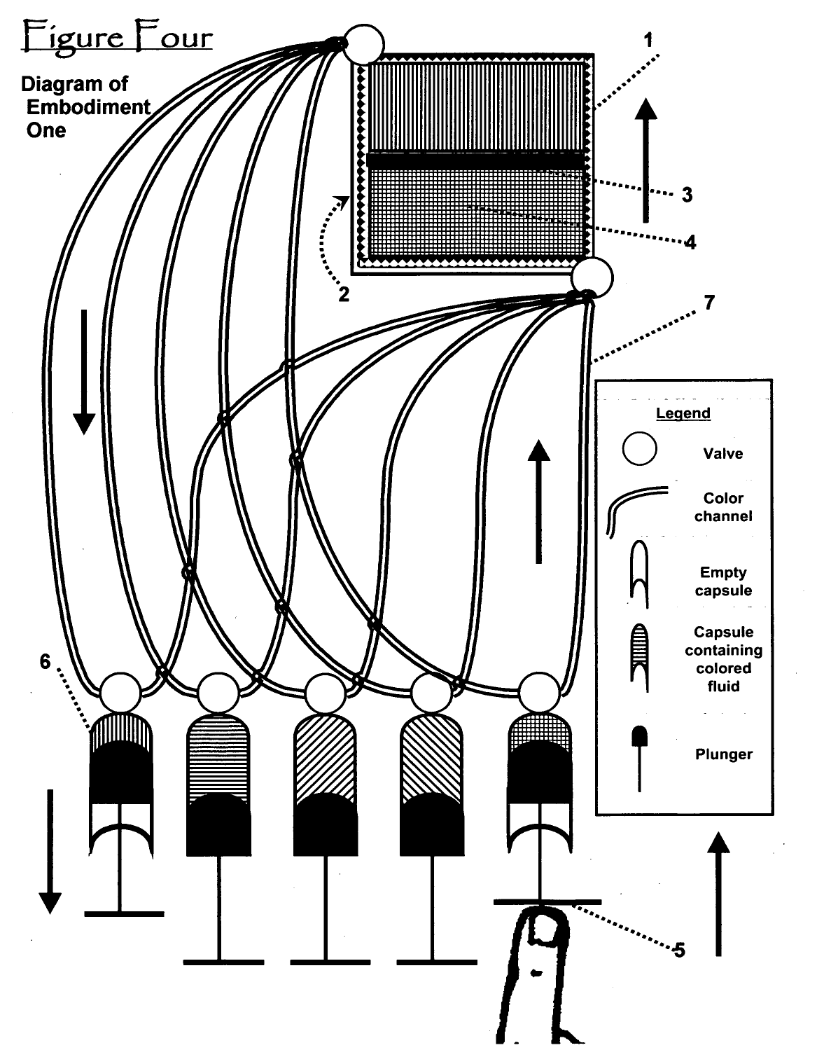

### (9) DETAILED DESCRIPTION OF THE INVENTION

### Detailed Description of Embodiment One

Embodiment One is a color-changing, light-diffusing panel for use with a recessed light fixture which could be located in a wall, ceiling, floor or pavement. For the purpose of this description, we will assume it to be located in a low ceiling of a private home.

Embodiment One will consist of:

1. A light-diffusing panel of appropriate shape and size to cover the recess in which the light fixture has been placed. Neither the recess, the fixture, nor the light-diffusing property of the panel form, per se, a part of the invention.

2. A transparent panel, similar in size and shape to the light-diffusing panel 1, and placed parallel to the light-diffusing panel 1, either above or below it, with a small space between the two panels.

3. A diaphragm which functions like a squeegee, located between panel 1 and panel 2.

4. A watertight, airtight reservoir, formed by means of a seal, caulking or gasket, between panel 1 and panel 2, with the diaphragm 3 being inside said reservoir, and lying against one side of it. Said reservoir is filled with fluid of a particular color. For the purpose of clarity, we will assume this color to be red, producing a red filter for the light produced by the bulb in the recessed fixture.

5. A user interface in the form of a row of buttons, located on the surface of the ceiling at one side of the reservoir 4. Most users will perceive this interface as being located next to the light. Each button is of a unique color. For the purpose of demonstration, we will assume five buttons, which are red, yellow, green, blue and white respectively. The red button s horizontal surface is flush with the ceiling, and all the remaining buttons protrude from the ceiling.

6. A row of capsules, fitted with plungers and each containing fluid of a unique color. The capsules are positioned vertically, with their plunger-ends facing downward, toward the room. The color of each capsule s fluid matches the color of one of the buttons 5 (with leeway given for slight variations due to differences in media, etc.) Each plunger is manufactured as one piece with one of the buttons 5, the color of each capsule s fluid corresponding to that of its plunger button. In our example, the capsule intended to contain red fluid, contains no fluid presently, since the red fluid is in the reservoir 4.

7. A number of tubes or channels equal to twice the number of capsules 6. In our five-color example, there must be ten channels. Five of these channels connect to the reservoir 4 via a small hole which has been formed in the seal and is governed by a valve or hub. Each of these five channels connects to one of the capsules 6 at the upper end of each capsule. The remaining five channels connect to the reservoir 4 via a second small hole formed in the seal at the opposite extremity of the reservoir 4 from the first hole, and also governed by a valve or hub. Each of these five channels also connects to one of the capsules 6, at the upper end of each capsule.

At this setting, assuming the lamp in the recessed fixture to be switched on, the invention provides a red filter. The light is perceived to be red.

If the user wishes to change to a green filter, he or she will push the green button 5. This pressure will force the green fluid out of its capsule 6, through its channel 7, and into the reservoir 4, pushing the diaphragm 3 before it, and forcing the red fluid out of the reservoir 4, through its channel 7, and into its own capsule 6.

When the color change is complete, the horizontal surface of the green button will be flush with the ceiling, and that of the red button will protrude from the ceiling to the same extent as the other five buttons.

### Detailed Description of Embodiment Two

Embodiment Two is a window with the appearance of leaded stained glass, but in which each piece of glass can change color. Thus it is possible to create a moving stained-glass picture.

In this embodiment each piece of glass is a reservoir, of which both panels are transparent. Their edges may be beveled to further enhance the window s beauty. Each strip of leading hides the necessary channels. Capsules may be placed in any convenient location. In this case it would probably be most reasonable to form many capsules together as one piece of plastic or other suitable material, as follows:

Form a tube which is not round, but if viewed from one end, has an oblong shape. Leave an opening in the side of said tube, which extends the whole length of the tube. Therefore, if viewed from the end, it now has a horseshoe shape.

Divide said horseshoe-shaped tube into many capsules by forming many walls inside it. Fit a plunger into each capsule. Form holes in the capsules through which each can send and receive fluid.

In this embodiment, the flow of fluid is controlled by electromagnetic switches, which in turn are controlled by a computer.

When the user wishes to change the appearance of the window, he or she will upload to the window s computer a design, picture or video file, and the computer will assign the appropriate-colored fluid to each reservoir, and specify when and for how long each color will reside in each reservoir.

1-2. (canceled)

3. Construction
The surface of the color-changing object is composed of one or more display reservoirs capable of containing a fluid or granular solid. At least a portion of each reservoir is transparent or translucent. Each reservoir is connected to one or more color-storage capsules containing fluid or granular solid.

4. Function
To change the color of the object, a fluid or granular solid is caused to flow from a capsule(s) into a reservoir(s). The fluid or granular solid will then be visible through the transparent or translucent portion(s) of the reservoir(s), thereby changing the color of the object. To change the color of the object again, the fluid or granular solid in the reservoir(s) is caused to flow back into its capsule(s), and a differently-colored fluid or granular solid can be caused to flow from a different capsule(s) into the reservoir(s). If necessary, a diaphragm can be placed in each reservoir to prevent the mixing of colors. Hydraulic pressure, electromagnetic switches or any other available means may be used to cause the fluid(s) or granular solid(s) to flow between the capsule(s) and the reservoir(s).
